(19) United States
(12) Patent Application Publication
(10) Pub. No.: US 2007/0212291 A1
(43) Pub. Date: Sep. 13, 2007

(54) Method And Apparatus For Purifying Inorganic Halides And Oxyhalides Using Zeolites

(75) Inventor: Troy Scoggins, San Diego, CA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Entegris, Inc., Chaska, MN (US)

(21) Appl. No.: 10/593,388

(22) PCT Filed: Mar. 10, 2005
(86) PCT No.: PCT/US05/08006

§ 371 Date: Oct. 5, 2006

Related U.S. Application Data
(60) Provisional application No. 60/554,768, filed on Mar. 19, 2004.

(51) Int. Cl. C01B 33/00

(52) U.S. Cl. 423/462; 210/348

(57) ABSTRACT

The present invention is directed to methods and apparatus for purifying inorganic halides and/or oxyhalides. In one embodiment, the method of the present invention includes contacting an inorganic halide or oxyhalide feed liquid with a zeolite to produce a purified inorganic halide or oxyhalide liquid. In one embodiment, the zeolite is a type-Y zeolite in a hydrogen form. In another aspect, the present invention includes an apparatus for purifying an inorganic halide or oxyhalide. The apparatus comprises: (a) a liquid filtration housing including a liquid inlet and a liquid outlet; and (b) a type-Y zeolite in a hydrogen form. Molecular and/or ionic impurities can be removed from the feed liquid using a filtration media that includes a zeolite. In a preferred embodiment, both molecular and ionic impurities are removed from the feed liquid using filtration media that includes a zeolite.

### RELATED APPLICATION

This application claims the benefit of U.S. Provisional Application No. 60/554,768, filed Mar. 19, 2004, the entire teachings of which are incorporated by reference herein.

### BACKGROUND OF THE INVENTION

Inorganic halides and oxyhalides such as, for example, silicon tetrachloride (SiCl₄), germanium tetrachloride (GeCl₄) and phosphorus oxychloride (POCl₃), are of particular interest in numerous industries including optical fiber manufacturing and semiconductor device manufacturing. The content of impurities in these substances is often critical for the appearance and/or performance of the end products.

The content of impurities in SiCl₄, used in the manufacture of electronic grade silicon affects the purity of the monocrystalline silicon wafers and limits the density of the circuits formed on the wafers. The presence of metallic contaminants in POCl₃, used in semiconductor device processing to improve the polycrystalline silicon conductivity may create defects in the polycrystalline silicon layer and deleteriously effect electrical properties of the semiconductor device. Semiconductor devices contaminated with unacceptable levels of metallic impurities can even become inoperative as a result of electrical shorts of their microelectronic circuits.

In optical fiber manufacturing, liquid compounds such as SiCl₄, GeCl₄ and POCl₃ are used to form the optical fiber and to influence its properties such as, for example, glass expansion coefficient, melt-viscosity and refractive index. Some impurities in these liquid compounds can be detrimental to the light transmission through the optical fiber. Oxygen and hydrocarbon bearing impurities can cause losses in light transmission through the optical fiber. Metallic impurities in optical fiber can increase attenuation of the signal in the fiber, decreasing the effective fiber length and thus requiring the use of amplifiers. Metallic impurities in optical fiber also can create highly absorptive areas, which can affect light transmission through the fiber. Molecular impurities containing the O—H bond can interfere with the wavelengths that are used to transmit information and can decrease the bandwidth of the fiber. As a result, additional investment into transmission equipment, e.g., extra amplifiers, is typically necessary to compensate for degraded performance.

To avoid the above-mentioned and other problems that the impurities may cause, manufacturers presently use expensive high purity grades of the inorganic halide and oxyhalide compounds. Moreover, the high purity grade compounds can re-collect impurities, for example, during their transportation, storage and/or use in the facilities of the end-product manufacturer. Sources of the impurities include, for example, exposure of the compounds to air and leaching of impurities from storage and/or transmission apparatuses.

Existing methods for purifying some inorganic halide and oxyhalide compounds include gas phase purification. However, gas phase purification typically requires a relatively large input of energy to vaporize the compounds and maintain them in a gas phase. In addition, gas phase purification systems typically are not suited to point of use purification of inorganic halide and oxyhalide compounds. For example, after vaporization of an inorganic halide or oxyhalide compound, e.g., SiCl₄, with a carrier gas, e.g., O₂, the concentration of the inorganic halide and oxyhalide compound in the gas phase should be maintained. However, gas phase purification systems placed downstream of the vaporization step can cause variation in the concentration of the inorganic halide or oxyhalide compound in the gas stream. Also, gas phase purification systems can have unacceptably high pressure drops when placed after vaporization of the inorganic halide or oxyhalide compound.

### SUMMARY OF THE INVENTION

The present invention is directed to a method and apparatus for purifying inorganic halides and/or oxyhalides. In one embodiment, the method of the present invention includes contacting an inorganic halide or oxyhalide feed liquid with a zeolite to produce a purified inorganic halide or oxyhalide liquid. In one embodiment, the zeolite is a type-Y zeolite in a hydrogen form. In another aspect, the present invention includes an apparatus for purifying an inorganic halide or oxyhalide feed liquid. The apparatus comprises: (a) a liquid filtration housing including a liquid inlet and a liquid outlet; and (b) a type-Y zeolite in a hydrogen form. In one embodiment, the liquid filtration housing is composed of perfluoroalkoxy (PFA) or polytetrafluoroethylene (PTFE).

Molecular and/or ionic (e.g., metal ion) impurities can be removed from an inorganic halide or oxyhalide feed liquid using a filtration media that contains a zeolite. In a preferred embodiment, both molecular and ionic impurities are removed from the feed liquid using filtration media that includes a zeolite.

In some embodiments, the zeolite used in the present invention is in the acidic or proton form, has a silica-to alumina ratio of at least about 5 and contains low concentrations of alkali or alkaline earth metals. In one embodiment, the zeolite is heated to remove volatile species and then cooled prior to contacting the zeolite with the inorganic halide and/or oxyhalide feed liquid.

Advantageously, practice of the present invention results in simple and effective purification of liquid inorganic halides and/or oxyhalides, particularly at their point of use or at their point of manufacture. By practicing the methods described herein, the difficulties associated with gas phase purification, such as maintaining pressures and concentrations in vapor inorganic halide and oxyhalide feed streams, can be avoided.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a schematic drawing of an apparatus for suitable for practicing the methods of the present invention.

FIG. 2 is a FT-IR spectrum of a control sample of liquid SiCl₄.

FIG. 3 shows the difference in FT-IR spectra of liquid SiCl₄ before and after purification by contacting zeolite CBV 400 with the liquid inorganic halide.

FIG. 4 shows the difference in FT-IR spectra of liquid SiCl₄ before and after purification by contacting zeolite CBV 780 with the liquid inorganic halide.

FIG. 5 shows the difference in FT-IR spectra of liquid SiCl₄ before and after purification by contacting silica gel with the liquid inorganic halide.

### DETAILED DESCRIPTION OF THE INVENTION

The present invention is directed to methods and apparatus for purifying inorganic halides and/or oxyhalides. In one embodiment, the method of the present invention includes contacting an inorganic halide or oxyhalide feed liquid with a zeolite to produce a purified inorganic halide or oxyhalide liquid. The invention is based upon the discovery that molecular and/or ionic (e.g., metal ion) impurities can be removed from the feed liquid using a filtration media that includes a zeolite. In a preferred embodiment, both molecular and ionic impurities are removed from the feed liquid using filtration media that includes a zeolite.

As the complete removal of particular impurities can be either unachievable or impossible to detect, the words “purification,” “purify,” “remove,” “removing,” and “removal” and the like, as used herein, are intended to mean that a significant proportion or detectable portion of an impurity is removed from the feed liquid. The significant proportion or detectable portion of an impurity that is removed will depend on the particular impurity and the processing conditions. For example, an impurity concentration of the inorganic halide or oxyhalide liquid can be reduced to less than about 10, 8, 6, 4, 2, or less than 1 parts per billion (10⁹) (ppb). In some embodiments, an impurity concentration of the inorganic halide or oxyhalide liquid can be reduced below the limit of detection.

In one embodiment, molecular impurities removed by the method of the present invention can include aliphatic hydrocarbons and compounds such as those containing a chemical bond selected from the group consisting of C—H, Si—H, Si—OH, O—H, C—Cl and C—O.

In addition, while substantially reducing the concentration of molecular impurities in liquid inorganic halides and/or oxyhalides, the zeolites used in the purification method described herein are capable of removing metal impurities such as metal ion impurities. In some embodiments, practice of the present method can reduce the concentration of metals such as, but not limited to, aluminum, antimony, barium, calcium, chromium, cobalt, copper, iron, magnesium, manganese, nickel, potassium, sodium, strontium, tin and zinc. The concentration of many of these metals can be reduced to create purified liquid inorganic halides and oxyhalides.

One of the advantages of the processes and apparatus of this invention is that both molecular and ionic impurities can be effectively removed from liquid inorganic halides and oxyhalides. In one embodiment, molecular and metal impurities are removed from an inorganic halide or oxyhalide feed liquid in one step. Another advantage is that the processes and apparatus of this invention can be easily integrated into existing purification processes of inorganic halides and oxyhalides or into the industrial processes where the liquid inorganic halides and oxyhalides are used.

The halides and oxyhalides can be purified at their point of use and thus manufacturing costs of the end-product can be reduced. For example, the manufacturer can purchase less pure grades of liquid halides and oxyhalides which are typically less expensive. Also advantageously, practice of the present invention, when applied at the point of use, can reduce the impurity concentration in halides and oxyhalides to more consistent levels, thus eliminating fluctuations in impurity concentrations. Fluctuations in impurity concentrations can be caused, for example, by variations in halide and oxyhalide manufacturing processes or by the random re-collection of impurities in a previously purified halide or oxyhalide liquid. Purification at the point of use can reduce the exposure of a compound to impurity sources by decreasing the time and/or spatial distance between the points of purification and use in a manufacturing process. By improving the consistency of the purified liquid inorganic halides and oxyhalides, such as by reducing the exposure of the liquids to impurity sources using point of use purification, end products with more reproducible characteristics can be manufactured.

Practice of the present invention can reduce energy requirements for purification of inorganic halides and oxyhalides over conventional gas phase purification schemes. For example, the inventive process described herein can be an essentially energy passive process, requiring little or no energy input (apart from any required pumping energy) to purify the compounds of interest. Thus, the present invention can be practiced at room temperature. The present invention includes a method and apparatus for purification of inorganic halides and oxyhalides as liquids. The removal of impurities from liquid compositions is needed since many industrial processes are designed such that point of use vapor phase purification is impractical and thus the invention facilitates point of use purification of inorganic halides and oxyhalides.

Zeolites suitable for practicing the present invention include synthetic zeolites and modified variations of both naturally occurring and synthetic zeolites. Particularly effective zeolites for purifying liquid halides and oxyhalides include those that have high silica-to-alumina mole ratios and/or that have low concentrations of alkali or alkaline earth metals.

For example, the zeolites particularly suited for use in practice of the present invention include zeolites that have a silica-to-alumina (SiO₂ to Al₂O₃) mole ratio of at least about 5. In some embodiments, the zeolite has a silica-to-alumina mole ratio of at least about 10, 20, 40, or at least about 80. For example, the zeolite can be CBV 400 with an alumina-to-silica mole ratio of 5.1 or CBV 780 with an alumina-to-silica mole ratio of 80. Zeolites CBV 400 and CBV 780 are obtainable from Zeolyst International (Valley Forge, Pa.). Zeolites having an appropriate alumina-to-silica mole ratio can be obtained commercially, or alternatively, can be prepared using techniques known to those of ordinary skill in the art. For example, the silica-to-alumina mole ratio of a chosen zeolite can be increased, e.g., by removing aluminum from the structural framework of the zeolite. Methods for removing aluminum from the structural framework of a zeolite are known in the art and can include, for example, chemical and hydrothermal treatments.

Zeolites are preferred that have concentrations of alkali or alkaline earth metals such that substantial contamination of the purified halide or oxyhalide by the alkali or alkaline earth metals is prevented. For example, the zeolites can have alkali and alkaline earth metal concentrations of less than about 3, 2, 1, 0.1 or less than about 0.05 weight percent alkali and alkaline earth metals. Alkali and alkaline earth metals include lithium (Li), sodium (Na), potassium (K), beryllium (Be), magnesium (Mg) and calcium (Ca). In some embodiments, discussed further infra, the inorganic halide and/or oxyhalide liquid can contain concentrations of alkali or alkaline earth metals following contact with the zeolite and can be directed through another filtration medium, e.g., silica gel, to reduce concentrations of alkali or alkaline earth metals in the liquid.

“Substantial contamination” of the purified inorganic halide or oxyhalide by an alkali or alkaline earth metal includes a concentration of alkali or alkaline earth metal that is unacceptable for the use of the halide or oxyhalide in an appropriate manufacturing process, e.g., in semiconductor device or optical fiber production.

In one embodiment, the zeolite used to practice the present invention has an alkali or alkaline earth metal content, e.g., sodium in the Na₂O form, that prevents substantial alkali or alkaline earth metal contamination of the liquid product and/or that promotes removal of alkali or alkaline earth metal from the liquid feed. For example, the zeolite can contain less than about 5, 4, 3, 2, 1, 0.1 or less than about 0.05 weight percent of a compound containing an alkali or alkaline earth metal, e.g., the zeolite contains less than about 3 weight percent sodium oxide (Na₂O) such as, for example, less than about 2, 1, 0.1, or less than about 0.05 weight percent Na₂O. Zeolites having an appropriate alkali or alkaline earth metal content can be obtained commercially, or alternatively, can be prepared using techniques known to those of ordinary skill in the art. In one embodiment, the alkali or alkaline earth metal content (e.g., sodium) of a chosen zeolite is decreased, for example, by ion exchange with an appropriate solution. Appropriate ion exchange solutions are known to those of ordinary skill in the art.

Examples of zeolites suitable for use in the invention include, but are not limited to, faujasite, zeolite Y (“type-Y” or “Y-type” zeolite) and zeolite ultrastable Y (“USY”). In one embodiment, the zeolite used to practice the present invention is in the hydrogen, or proton, form. In a preferred embodiment, the zeolite is a type-Y zeolite, for example, a type-Y zeolite in a hydrogen form. In one embodiment, a NH₄⁺ containing zeolite can be heated to eliminate NH₃ and to form a hydrogen form zeolite that is suitable for use with the present invention.

The pore size of suitable zeolites can vary. In one embodiment, the zeolite has a mean pore size of about 20 to about 30 Angstroms, for example, about 22 to about 28 Angstroms, about 24 to about 26 Angstroms, or about 24 to about 25 Angstroms.

Specific examples of suitable zeolites include, but are not limited to, CBV 400, CBV 600, CBV 720, CBV 760, CBV 780 and CBV 901, all commercially available from Zeolyst International (Valley Forge, Pa.). These zeolites are all hydrogen form, Y-type zeolites having a Brunauer-Emmett-Teller (BET) surface area of 660 to 780 m²/gram, SiO₂-to-Al₂O₃ mole ratios of 5.1 to 80, 0.03 to 2.8 weight percent Na₂O and a unit cell size of 24.24 to 24.50 Angstroms.

Zeolites for practicing the present invention are preferably in the hydrogen (i.e., proton or acidic) form. Zeolites having the hydrogen form can be manufactured using any of a variety of techniques known to those of ordinary skill in the art. For example, zeolites in the ammonium cationic form, e.g., CBV 300, CBV 500 and CBV 512 (ammonium form, Y-type zeolites having a BET surface area of 730 to 925 m²/gram, SiO₂-to-Al₂O₃ mole ratios of 5.1 to 12, 0.05 to 2.8 weight percent Na₂O and a unit cell size of 24.35 to 24.68 Angstroms), commercially available from Zeolyst International, can be heated to sufficiently remove ammonia, cooled, and used to practice the invention. Hydrogen form zeolites can also be manufactured using zeolite ion exchange.

Unexpectedly, zeolites used in the present invention do not require high-temperature preheating or other relatively complicated preconditioning steps. For example, zeolites used in the present invention do not need to be heated to temperatures of about 400° C. or more such as about 500° C., 600° C., about 700° C. or more prior to contacting the feed liquid with the zeolite. In one preferred embodiment, the zeolites employed in the present invention are substantially free of volatile species. To remove volatile species, the zeolite can be heated under an inert atmosphere. For example, the zeolite can be heated under purified nitrogen to about 100° C. to about 200° C., e.g., at least about 150° C., for a period of time sufficient to drive off volatile species (e.g., atmospheric gases such as, for example, N₂, O₂, CO₂, and/or H₂O) contained therein. For example, the zeolite can be heated under purified nitrogen to at least about 150° C. for at least about 3, 4, 5, or at least about 6 hours to drive off volatile species contained therein. Preferably, the zeolite is then cooled, e.g., to, or near, room or ambient temperature, prior to contacting the feed liquid. The method of the invention, however, can optionally comprise either (1) contacting the feed liquid with the zeolite without separately cooling the zeolite, e.g., the temperature of the zeolite can be about 150° C. or less; or (2) maintaining the zeolite at an elevated temperature, e.g., at about 150° C., prior to its contact with the feed liquid. In one embodiment, the zeolite is stored in a non-contaminating environment, e.g., a sealed container or filtration cartridge, until the zeolite is contacted with the halide or oxyhalide feed liquid.

The purification efficiency using the zeolite can be influenced, in part, by the size of the zeolite's particles. Increased efficiency can result from reducing the size of the zeolite particles. For example, the size of the zeolite particles can be reduced prior to the above-described zeolite heating. It is believed that by reducing the particle size of the zeolite, more feed liquid can be contacted with the zeolite particles per unit time. Methods for reducing the size of zeolite particles are known to those of ordinary skill in the art and can include, but are not limited to, milling, sieving and grinding. For example, a grinding mill such as a Quaker City Grinding Mill Model F-4 (Straub Co., a division of Clinton Separators, Inc.; Philadelphia, Pa.) can be used to size reduce the zeolite particles. In one embodiment, the zeolites of the invention have a substantially homogenous particle size. For example, the zeolites can be size classified, e.g., using sieve classification. In one embodiment, the zeolite particles have a minimum size greater than about 90 microns, for example, the zeolite particles are about 90 to about 180 microns (e.g., CBV 780 particles of about 90 to about 180 microns). Zeolite particles having a minimum size greater than about 400 microns, for example, about 425 microns (e.g., CBV 400 particles of about 425 microns), also can produce effective purification of liquid inorganic halides and oxyhalides. In an alternative embodiment, a mixture of zeolite having various particle sizes is used.

In one aspect, the present invention is directed to an apparatus and method for purifying inorganic halides and/or oxyhalides. In one embodiment, the feed liquid is substantially all inorganic halide and/or oxyhalide with only traces of contaminants present.

In one aspect, the invention is directed to an apparatus and a method for purifying compounds used in the manufacture of semiconductor devices. In another aspect, the invention includes an apparatus and a method for purifying compounds used in the manufacture of optical fiber. For example, the apparatus and methods described herein can be used to purify feed liquids that include one or more compounds such as, but not limited to, silicon tetrachloride (SiCl₄), germanium tetrachloride (GeCl₄) and phosphorus oxychloride (POCl₃).

In one embodiment, the inorganic halides and/or oxyhalides can be purified prior to introduction to a manufacturing process, e.g., a semiconductor production process, an optical fiber production process, or any process requiring purified inorganic halides and/or oxyhalides. For example, the inorganic halides and/or oxyhalides can be purified by a bulk chemical manufacturing process and can be then packaged or stored for later use in a product manufacturing process. In one embodiment, the liquid inorganic halides and/or oxyhalides can be purified at the point of use. For example, a semiconductor device or optical fiber production process can employ the apparatus or method for the purification of the liquid inorganic halides and/or oxyhalides just prior to their use in the manufacturing process. In one embodiment, the liquid inorganic halides and/or oxyhalides can be at least partially purified prior to introduction to a manufacturing process and can be then further purified just prior to use in the manufacturing process.

The liquid inorganic halides and/or oxyhalides can be purified using the methods described herein in batch, continuous, and/or semi-continuous processes. In some embodiments, the liquid inorganic halides and/or oxyhalides can be purified by holding the halide or oxyhalide over a zeolite in a batch process. In other embodiments, the liquid inorganic halides and/or oxyhalides can be purified by employing a flow-through apparatus, e.g., wherein liquid is introduced to the apparatus and purified liquid is gradually withdrawn from the apparatus. For example, a process for the manufacture of a product (e.g., optical fiber) can include a flow-through apparatus for purifying the liquid inorganic halides and/or oxyhalides as an integral part of the manufacturing process. One of ordinary skill in the art can determine positioning of a flow-through apparatus for any particular process. For example, a flow-through apparatus can be positioned prior to a bubbler or prior to any storage, retention, or shipping vessel. Advantageously, practice of the present invention results in simple and effective purification of liquid inorganic halides and/or oxyhalides at their point of use or at their point of manufacture.

Contamination of inorganic halides and oxyhalides by alkali or alkaline earth metals such as, for example, lithium, sodium, potassium, beryllium, magnesium, and/or calcium, can be detrimental for some applications using the inorganic halides or oxyhalides. For example, the presence of sodium within or on interfaces of silicon layers of semiconductor devices can result in the degradation of the device's electrical characteristics.

By contacting the feed liquid with both silica gel and a zeolite, alkali and alkaline earth metal, e.g., sodium, concentrations in the purified liquid can be minimized or substantially eliminated. In one embodiment, the liquid is serially purified with either silica gel and then the zeolite or with the zeolite and then silica gel. For example, in one method, a liquid including inorganic halides or oxyhalides is contacted with a zeolite, removed from the zeolite, contacted with silica gel, and then removed from the silica gel. Such a serial purification can be a continuous, semi-continuous, or batch process. In another embodiment, the liquid is purified by contact with a mixture of silica gel and zeolite.

In some embodiments, effective removal of alkali and alkaline earth metals such as sodium from the feed liquid can be achieved by using zeolites having low concentrations of alkali or alkaline earth metals. For example, the zeolite can have less than about 0.1 or less than about 0.05 weight percent Na₂O.

In one aspect, the present invention includes an apparatus for purifying an inorganic halide or oxyhalide. The apparatus comprises: (a) a liquid filtration housing including a liquid inlet and a liquid outlet; and (b) a type-Y zeolite, e.g., a type-Y zeolite in a hydrogen form. In one embodiment, the apparatus includes: (a) a liquid filtration housing including a liquid inlet and a liquid outlet; and (b) a hydrogen form zeolite, e.g., a type-Y zeolite in a hydrogen form. The apparatus can further comprise a filtration media retention device, e.g., a zeolite retention device, to retain the filtration media within the liquid filtration housing. In some embodiments, the filtration media retention device includes a filter or a screen. Preferably, the liquid filtration housing and the filtration media retention device are composed of a chemical resistant material that is resistant to contaminating a liquid inorganic halide or oxyhalide. For example, the liquid filtration housing and the filtration media retention device can be composed of perfluoroalkoxy (PFA) or polytetrafluoroethylene (PTFE). In another embodiment, the liquid filtration housing can be composed of stainless steel, e.g., the liquid filtration housing can be composed of stainless steel and the filtration media retention device can be composed of PFA or PTFE. In one embodiment, the apparatus includes a replaceable liquid filtration housing (e.g., a filtration cartridge) that contains the zeolite filtration media. For example, the apparatus can include a disposable liquid filtration housing (e.g., a filtration cartridge) for the filtration media. In one embodiment, the apparatus includes a zeolite that has been treated to remove volatile species as described supra. Preferably, the shelf-life of the apparatus can be at least about 3 to at least about 6 months. In some embodiments, the zeolite contained in the apparatus can be regenerated by removing volatile species as described supra. For example, the zeolite contained in the apparatus can be regenerated by removing volatile species before a first use of the apparatus or following one or more uses to purify an inorganic halide or oxyhalide.

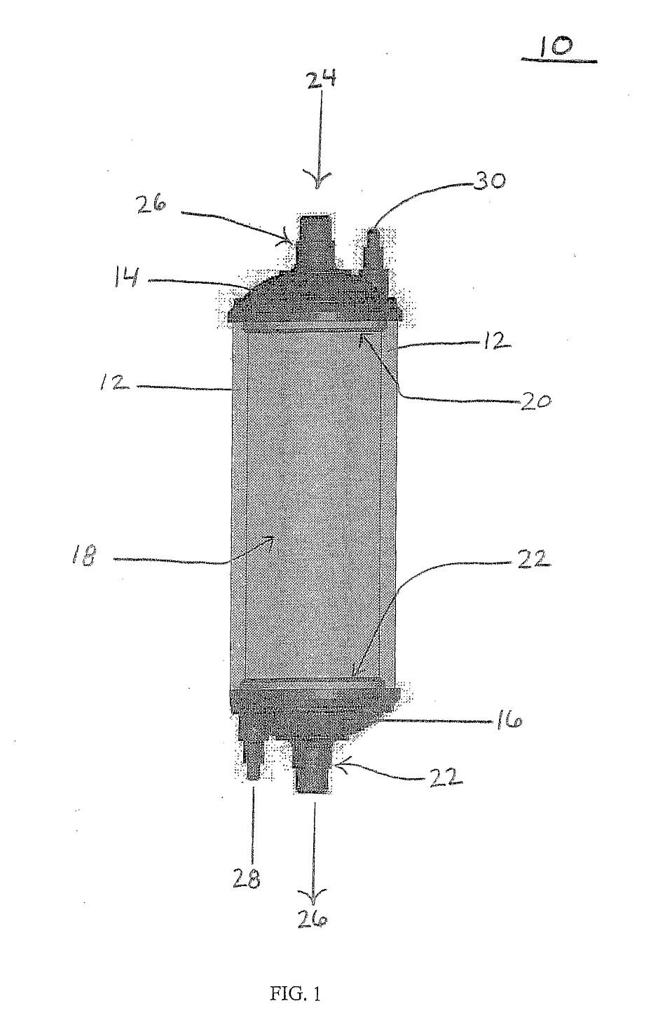

FIG. 1 is an illustration of one example of an apparatus suitable for practicing the purification of liquid inorganic halides and/or oxyhalides described herein. Purification apparatus 10 includes liquid filtration housing 12 having covers 14 and 16. Liquid filtration housing 12, with included covers 14 and 16, functions to contain liquid and filtration media 18 within the apparatus and to help prevent contamination of the liquid, e.g., by preventing or minimizing exposure of filtration media 18 or the halides and oxyhalides to atmospheric air.

Media retention devices 20 and 22 function to help retain filtration media 18 within the apparatus. In one embodiment, the media retention devices are filters having a mesh size of less than about 50 microns such as, for example, less than about 40, 30, 20, or less than about 10 microns. In some embodiments, the media retention devices are porous polytetrafluoroethylene (PTFE) and/or HEPA-type filters.

Preferably, the surfaces of liquid filtration housing 12, including covers 14 and 16, and media retention devices 20 and 22 that are exposed to the liquid and filtration media 18 are composed of a material that is chemically stable, is resistant to temperature, and does not leach undesired contaminants into the liquid. For example, in one embodiment, the surfaces of liquid filtration housing 12, including covers 14 and 16, and media retention devices 20 and 22 that are exposed to liquid and filtration media 18 are composed of perfluoroalkoxy (PFA) or polytetrafluoroethylene (PTFE). In another embodiment, liquid filtration housing 12, including covers 14 and 16, and/or media retention devices 20 and 22 are composed entirely of perfluoroalkoxy (PFA) or polytetrafluoroethylene (PTFE). For example, the liquid filtration housing can be a CHEMGARD™ In-line Housing, commercially available from the Mykrolis Corporation (Billerica, Mass.). In another embodiment, liquid filtration housing 12, including covers 14 and 16, is composed of stainless steel.

Filteration media 18 includes a zeolite, as described supra. For example, the zeolite can be a type-Y, hydrogen form zeolite such as CBV 400 or CBV 780. In addition to a zeolite, filtration media 18 can also include one or more additional materials, for example, filtration media 18 also can contain silica gel, an additional zeolite, and/or a filler material, e.g., glass fiber. For example, in some embodiments, filtration media 18 can include a zeolite and silica gel in zeolite-to-silica gel weight ratios that include, but that are not limited to, about 60:40, 70:30, 80:20, 90:10, and about 95:5.

Covers 14 and 16 contain liquid ports 20 and 22, respectively. Liquid ports 20 and 22 can function as either inlets or as outlets for the liquid being purified. As illustrated, cover 14 contains liquid port 20 functioning as a liquid inlet and cover 16 contains liquid port 22 functioning as a liquid outlet. In a preferred embodiment, liquid ports 20 and 22 are composed of a material that is chemically stable, is resistant to temperature, and does not leach undesired contaminants into the liquid, e.g., perfluoroalkoxy (PFA) or polytetrafluoroethylene (PTFE). In preferred embodiments, liquid conduit connections (not illustrated) are made to liquid ports 20 and 22 wherein the liquid conduit is also composed of a material that prevents substantial contamination of the liquid.

Purge 28 can be used to remove residues of the liquid being purified from the interior surfaces of liquid filtration housing 12, including covers 14 and 16; the surfaces of media retention devices 20 and 22; and from filtration media 18. Purge 28 can be used in a purge of the apparatus for various process needs, identifiable to one of ordinary skill in the art. For example, a purge of the apparatus can be performed as periodic maintenance or to remove residual liquid in preparation for replacement of purification apparatus 10. Examples of substances that can be used to purge the apparatus include O₂, N₂, Ar, and extra clean dry air (XCDA®; Mykrolis Corporation; Billerica, Mass.).

Vent 30 can function to remove one or more gases from purification apparatus 10. For example, vent 30 can be used to vent gas displaced by the fed liquid during operational start-up of purification apparatus 10. Vent 30 can lead to an appropriate gas emission control device such as, for example, a gas scrubber.

In one embodiment not illustrated in FIG. 1, liquid filtration housing 12, including covers 14 and 16, contains only liquid ports 20 and 22 with purge 28 and vent 30 not present. For example, in one embodiment, liquid filtration housing 10, including covers 14 and 16, is composed of stainless steel and contains only one liquid inlet and one liquid outlet (liquid ports 20 and 22).

In an example of operation of the apparatus, feed liquid stream 24, containing inorganic halides and/or oxyhalides, is introduced to purification apparatus 10 via liquid port 20. The inorganic halides and/or oxyhalides then move through filtration media 18 to the opposite end of purification apparatus 10. Purified liquid stream 26, containing the purified inorganic halides and/or oxyhalides, then exits purification apparatus via liquid port 22. In one embodiment, purification apparatus 10 can be operated at ambient temperature, e.g., at room temperature such as about 21° C. to about 23° C. For example, feed liquid stream 24 can be introduced to purification apparatus 10 at ambient temperature, e.g., at room temperature such as about 21° C. to about 23° C. In some embodiments, purification apparatus 10 can be operated at pressures such as, e.g., less than about 7 bar. For example, purification apparatus 10 can be operated at less than 6, 5, 4, 3, less than about 2 bar, or at about atmospheric pressure.

Purification apparatus 10 can be used for a batch, semi-continuous, or continuous purification process by varying the inlet and/or outlet flow rates. For example, the apparatus can be operated in batch mode by closing liquid port 22; filling the apparatus with feed liquid stream 24 via liquid port 20; allowing the liquid to stand over filtration media 18 for a period of time; and then withdrawing purified liquid stream 26 by opening liquid port 22. Alternatively, the apparatus can be operated in a continuous flow-through mode, for example, by continuously introducing feed liquid stream 24 via liquid port 20 and continuously withdrawing purified liquid stream 26 via liquid port 22.

The necessary quantity of zeolite for the purification of a particular quantity of feed liquid will vary depending on factors such as the concentration of impurities in the liquid; product purity requirements; the composition of the filtration media, including the characteristics of the selected zeolite; and processing conditions such as temperature, pressure, and the flow rate of the fluid through the filtration media. One of ordinary skill in the art, without undue experimentation, can determine specific operating parameters such as the necessary quantity of zeolite, temperatures, pressures, the flow rate of the liquid through the filtration media, and the replacement frequency of the filtration media. In some embodiments, the zeolite can be regenerated by removing volatile species as described supra. For example, the zeolite can be regenerated following use to purify an inorganic halide or oxyhalide.

The invention will now be illustrated with reference to the following non-limiting examples.

### EXEMPLIFICATION

### Example 1A

The following example describes the removal of impurities from liquid silicon tetrachloride (SiCl₄) using the specialty zeolite CBV 400 obtained from Zeolyst International (Valley Forge, Pa.).

CBV 400 is a proton form, Y-type zeolite having a Brunauer-Emmett-Teller (BET) surface area of 730 m²/gram, a SiO₂-to-Al₂O₃ mole ratio of 5.1, and 2.8 weight percent Na₂O. The zeolite was size reduced using a Quaker City Grinding Mill Model F-4 (Straub Co., a division of Clinton Separators, Inc.; Philadelphia, Pa.) and size classified by sieving to produce zeolite particles greater than 425 microns. The size classified CBV 400 was then dried at about 150° C. for about 6 hours under purified nitrogen gas. The nitrogen gas was supplied from a liquid nitrogen bulk Dewar flask and purified using a MYKROLIS® inert gas purifier model no. WPGV202TI (MYKROLIS® is a trademark of Mykrolis Corporation; Billerica, Mass.).

Ten milliliters of CBV 400 prepared as described above was placed in a 50 milliliter buret having a perfluoroalkoxy (PFA) stopcock. PYREX® (a trademark of Corning Inc., Corning, N.Y.) glass wool was used to hold the CBV 400 in place. Twenty-five milliliters of SiCl₄ (99.998%, obtained from Sigma-Aldrich Co., St. Louis, Mo.) was then added to the buret and allowed to stand for 2-3 minutes. A few milliliters of the SiCl₄ was then dispensed from the buret and used to rinse a sample bottle (ChemTrace Inc., Fremont, Calif.) and then discarded. Twenty milliliters of SiCl₄ was then dispensed from the buret and captured in the sample bottle. This sample was reserved for subsequent trace metal analysis, described infra.

An additional 25 milliliters of SiCl₄ was then added to the buret and allowed to stand for 2-3 minutes. A few milliliters of the SiCl₄ was then dispensed from the buret and used to double rinse a I-CHEM brand sample bottle (Nalga Nunc International, Rochester, N.Y.) and then discarded. Twenty milliliters of SiCl₄ was then dispensed from the buret and captured in the I-CHEM bottle. This sample was reserved for subsequent Fourier Transform Infrared (FT-IR) spectroscopic analysis, described infra.

In both cases described above, the flow rate of SiCl₄ through the zeolite bed was approximately 1 milliliter per second.

### Example 1B

This example describes the use of Fourier Transform Infrared (FT-IR) spectroscopic analysis to determine the efficiency of molecular impurity removal from liquid SiCl₄ using the zeolite CBV 400.

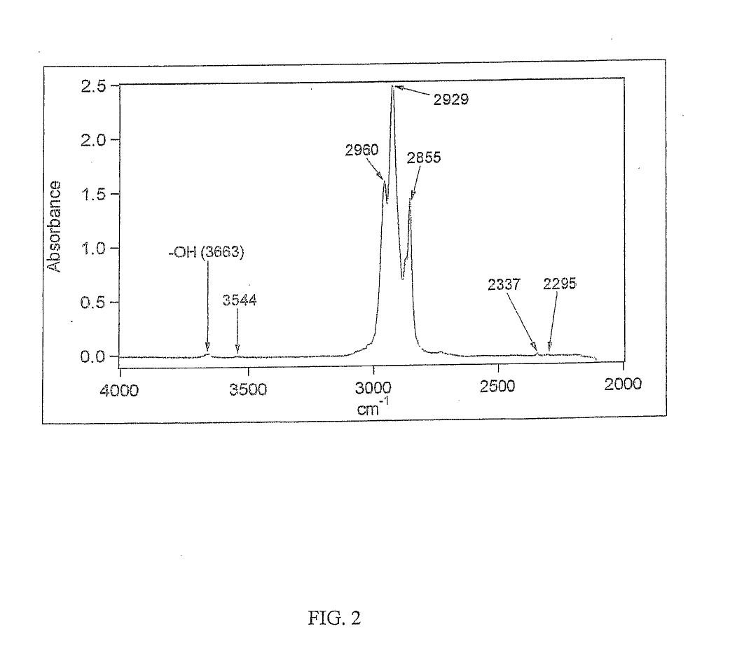

A Nicolet Magna 560 FT-IR spectrometer (Thermo Nicolet Corp., Madison, Wis.) was used to measure spectra of SiCl₄ samples. A background spectrum of an empty 100 millimeter quartz cell obtained from Wilmad (a division of SP Industries Inc., Buena, N.J.) was measured and stored for use as the background of the SiCl₄ sample spectra. The quartz cell was then moved to a glove box. A quantity of SiCl₄ (99.998%, obtained from Sigma-Aldrich) was taken from the bulk bottle and used to rinse both the transfer syringe and the quartz cell. More SiCl₄ was then taken from the bulk bottle, and the quartz cell was filled and capped. The filled quartz cell was then removed from the glove box, rinsed with High Performance Liquid Chromatography (HPLC) grade isopropyl alcohol (IPA), and dried with a Kim-Wipe. The quartz cell was quickly placed in the nitrogen-purged cavity of the FT-IR spectrometer. The cell cavity was purged for approximately three minutes. A SiCl₄ control sample spectrum (average of 64 scans) was taken using 0.5 cm⁻¹ resolution and is shown in FIG. 2.

Spectra of zeolite-purified SiCl₄ obtained as described in Example 1A was then measured using FT-IR spectroscopy. A sample of zeolite-purified SiCl₄ was loaded into the quartz cell using the same procedure as described above for the control sample, except that the zeolite-purified SiCl₄ was used to rinse the syringe and quartz cell.

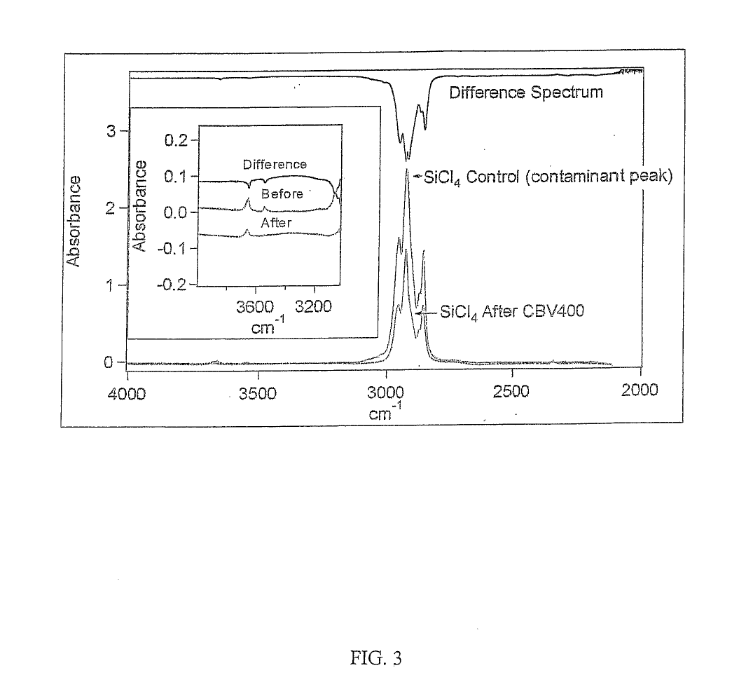

FIG. 3 shows the difference in FT-IR spectra for the CBV 400 zeolite-purified SiCl₄ versus the SiCl₄ control sample. Negative peaks in the Difference Spectrum indicate the removal of contaminants. Zeolite-purification of SiCl₄ reduced the peak at 3663 cm⁻¹, which is attributed to O—H containing contaminants. The reduction in peaks shown to the left of 3000 cm⁻¹ (at 2960 cm⁻¹ and at 2929 cm⁻¹, which are attributed to C—H stretching region; and at 2855 cm⁻¹, which is attributed to H—Cl stretching) indicates the ability of the CBV 400 zeolite to remove contaminants containing C—H bonds such as aliphatic hydrocarbons and HCl. Zeolite-purification of SiCl₄ also reduced the peak at 2295 cm⁻¹, which is attributed to Si—H stretching, and increased the peak at 2337 cm⁻¹, which is attributed to dissolved carbon dioxide (CO₂).

### Example 1C

This example describes the use of Inductively Coupled Plasma-Mass Spectrometry Analysis (ICP-MS) to determine the efficiency of metal removal from liquid SiCl₄ using the zeolite CBV 400.

Analysis of metal content of zeolite-purified SiCl₄ produced as described in Example 1A and a control SiCl₄ sample was made by ChemTrace Inc. (Fremont, Calif.).

The results for metal analysis of the SiCl₄ samples are shown in Table 1. Purification of liquid SiCl₄ using CBV 400 showed a reduction or a maintained concentration in all metals except sodium, where an increase from 1.6 to 6.6 parts per billion (10⁹) (ppb) was observed.

TABLE 1
Metal content of control SiCl₄ and zeolite-purified liquid SiCl₄

| | | | SiCl₄ After | SiCl₄ After | SiCl₄ After |
|---|---|---|---|---|---|
| | | SiCl₄ | CBV 400 | Silica Gel | CBV 780 |
| | Detection | Control | Treatment | Treatment | Treatment |
| Metal | Limit (ppb) | (ppb) | (ppb) | (ppb) | (ppb) |
| Aluminum (Al) | 0.05 | 7.2 | 1.2 | <0.05 | 0.37 |
| Antimony (Sb) | 0.05 | 0.96 | <0.05 | <0.05 | <0.05 |
| Arsenic (As) | 0.10 | <0.1 | <0.1 | <0.1 | <0.1 |
| Barium (Ba) | 0.01 | 0.16 | <0.01 | <0.01 | <0.01 |
| Beryllium (Be) | 0.05 | <0.05 | <0.05 | <0.05 | <0.05 |
| Bismuth (Bi) | 0.05 | <0.05 | <0.05 | <0.05 | <0.05 |
| Boron (B) | 0.10 | <0.1 | <0.1 | 0.17 | <0.1 |
| Cadmium (Cd) | 0.01 | <0.01 | <0.01 | <0.01 | <0.01 |
| Calcium (Ca) | 0.10 | 3.1 | 0.61 | 0.31 | 0.43 |
| Chromium (Cr) | 0.05 | 0.41 | <0.05 | <0.05 | <0.05 |
| Cobalt (Co) | 0.01 | 0.014 | <0.01 | <0.01 | <0.01 |
| Copper (Cu) | 0.05 | 0.90 | <0.05 | <0.05 | <0.05 |
| Gallium (Ga) | 0.01 | <0.01 | <0.01 | <0.01 | <0.01 |
| Germanium (Ge) | 0.05 | <0.05 | <0.05 | <0.05 | <0.05 |
| Gold (Au) | 0.10 | <0.1 | <0.1 | <0.1 | <0.1 |
| Iron (Fe) | 0.10 | 5.6 | 0.40 | 0.43 | 0.42 |
| Lead (Pb) | 0.05 | <0.05 | <0.05 | <0.05 | <0.05 |
| Lithium (Li) | 0.05 | <0.05 | <0.05 | <0.05 | <0.05 |
| Magnesium (Mg) | 0.05 | 3.4 | <0.05 | 0.10 | 0.070 |
| Manganese (Mn) | 0.05 | 0.067 | <0.05 | <0.05 | <0.05 |
| Molbdenum (Mo) | 0.05 | <0.05 | <0.05 | 0.11 | <0.05 |
| Nickel (Ni) | 0.05 | 0.37 | <0.05 | <0.05 | <0.05 |
| Niobium (Nb) | 0.05 | <0.05 | <0.05 | <0.05 | <0.05 |
| Potassium (K) | 0.10 | 0.69 | 0.35 | <0.1 | 0.81 |
| Silver (Ag) | 0.05 | <0.05 | <0.05 | <0.05 | <0.05 |
| Sodium (Na) | 0.10 | 1.6 | 6.6 | 0.68 | 0.92 |
| Strontium (Sr) | 0.01 | 0.019 | <0.01 | <0.01 | <0.01 |
| Tantalum (Ta) | 0.05 | <0.05 | <0.05 | <0.05 | <0.05 |
| Thallium (Tl) | 0.01 | <0.01 | <0.01 | <0.01 | <0.01 |
| Tin (Sn) | 0.05 | 0.10 | <0.05 | <0.05 | <0.05 |
| Titanium (Ti) | 0.05 | <0.05 | <0.05 | <0.05 | <0.05 |
| Vanadium (V) | 0.05 | <0.05 | <0.05 | <0.05 | <0.05 |
| Zinc (Zn) | 0.05 | 2.5 | <0.05 | 0.089 | 0.16 |
| Zirconium (Zr) | 0.01 | <0.01 | <0.01 | <0.01 | <0.01 |

CBV 400 effectively removed molecular and metal impurities from liquid SiCl₄. The observed increase in sodium concentration is thought to result from the relatively high sodium oxide content in the CBV 400 zeolite.

### Example 2A

The following example describes the removal of impurities from liquid silicon tetrachloride using the specialty zeolite CBV 780 obtained from Zeolyst International (Valley Forge, Pa.).

CBV 780 is a proton form, Y-type zeolite having a BET surface area of 780 m²/gram, a SiO₂-to-Al₂O₃ mole ratio of 80, and 0.03 weight percent Na₂O. Following size reduction using a Quaker City Grinding Mill Model F-4 and size classification by sieving, the particle size of the CBV 780 was about 90 microns to about 180 microns. The CBV 780 was then dried at about 150° C. for about 6 hours under purified nitrogen gas. The nitrogen gas was supplied from a liquid nitrogen bulk Dewar flask and purified using a MYKROLIS® inert gas purifier model no. WPGV202TI.

Twenty-five milliliters of CBV 780 prepared as described above was placed in a 50 milliliter buret having a perfluoroalkoxy (PFA) stopcock. PYREX® glass wool was used to hold the CBV 780 in place. SiCl₄ (99.998%, obtained from Sigma-Aldrich Co., St. Louis, Mo.) was then added to the buret and allowed to work through the zeolite bed. The flow rate of SiCl₄ through the zeolite bed was approximately 0.4 milliliters per minute.

25 milliliters of SiCl₄ was dispensed from the buret and used to rinse and fill a 100 mm quartz FT-IR cell from Wilmad for subsequent FT-IR analysis, described infra. An additional 25 milliliters of SiCl₄ was then dispensed from the buret and used to double rinse and fill a pre-cleaned I-CHEM brand sample bottle. This sample was reserved for subsequent trace metal analysis, described infra.

### Example 2B

This example describes the use of Fourier Transform Infrared (FT-IR) spectroscopic analysis to determine the efficiency of molecular impurity removal from liquid SiCl₄ using the zeolite CBV 780.

SiCl₄ FT-IR spectra were measured using the same procedure described in Example 1B except that a sample of zeolite-purified SiCl₄ produced as described in Example 2A was used to rinse the syringe and quartz cell and for the subsequent measurements.

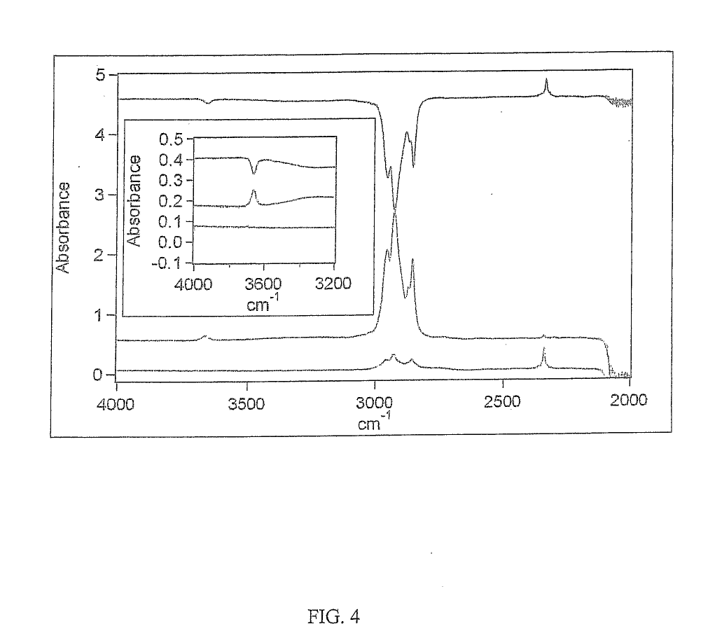

FIG. 4 shows the difference in FT-IR spectra for the CBV 780 zeolite-purified SiCl₄ versus a SiCl₄ control sample. Negative peaks in the Difference Spectrum indicate the removal of contaminants. Zeolite-purification of SiCl₄ reduced the peaks at 3663 cm⁻¹, 2960 cm⁻¹, 2929 cm⁻¹, 2855 cm⁻¹, and 2295 cm⁻¹, indicating that purification using CBV 780 reduced contaminants containing O—H, C—H, H—Cl and Si—H bonds. The peak at 2337 cm⁻¹, which is attributed to dissolved CO₂, increased after purification of the SiCl₄ using the zeolite.

### Example 2C

This example describes the use of Inductively Coupled Plasma-Mass Spectrometry Analysis (ICP-MS) analysis to determine the efficiency of metal removal from liquid SiCl₄ using the zeolite CBV 780.

Analysis of metal content of zeolite-purified SiCl₄ produced as described in Example 2A and a control SiCl₄ sample was made by ChemTrace Inc. (Fremont, Calif.).

The results for metal analysis of the SiCl₄ samples are shown in Table 1, supra. Purification of liquid SiCl₄ using CBV 780 showed a reduction in all metals except potassium, where an increase from 0.69 to 0.81 parts per billion (ppb) was observed.

Purification using CBV 780 effectively removed metal impurities from liquid SiCl₄, but did show a slight increase in potassium concentration. The reduced sodium concentrations are thought to result, at least partially, from the reduced sodium oxide content of the CBV 780 zeolite.

### Example 3A

The following example describes the removal of impurities from liquid silicon tetrachloride using silica gel (Davisil 38, 60-100 mesh, 99+ %) obtained from Sigma-Aldrich Co. (St. Louis, Mo.).

Ten milliliters of silica gel was placed in a 50 milliliter buret having a perfluoroalkoxy (PFA) stopcock. PYREX® (a trademark of Corning Inc., Corning, N.Y.) glass wool was used to hold the silica gel in place. Twenty-five milliliters of SiCl₄ (99.998%, obtained from Sigma-Aldrich Co., St. Louis, Mo.) was then added to the buret and allowed to stand for 2-3 minutes. A few milliliters of the SiCl₄ was then dispensed from the buret and used to rinse a sample bottle (ChemTrace Inc., Fremont, Calif.) and then discarded. Twenty milliliters of SiCl₄ was then dispensed from the buret and captured in the sample bottle. This sample was reserved for subsequent trace metal analysis, described infra.

An additional 25 milliliters of SiCl₄ was then added to the buret and allowed to stand for 2-3 minutes. A few milliliters of the SiCl₄ was then dispensed from the buret and used to rinse a I-CHEM brand sample bottle (Nalga Nunc International, Rochester, N.Y.) and then discarded. Twenty milliliters of SiCl₄ was then dispensed from the buret and captured in the I-CHEM bottle. This sample was reserved for subsequent Fourier Transform Infrared (FT-IR) spectroscopic analysis, described infra.

In both cases described above, the flow rate of SiCl₄ through the zeolite bed was approximately 0.5 milliliter per second.

### Example 3B

This example describes the use of Fourier Transform Infrared (FT-IR) spectroscopic analysis to determine the efficiency of molecular impurity removal from liquid SiCl₄ using silica gel.

SiCl₄ FT-IR spectra were measured using the same procedure described in Example 1B except that a sample of silica gel-purified SiCl₄ produced as described in Example 3A was used to rinse the syringe and quartz cell and for the subsequent measurements.

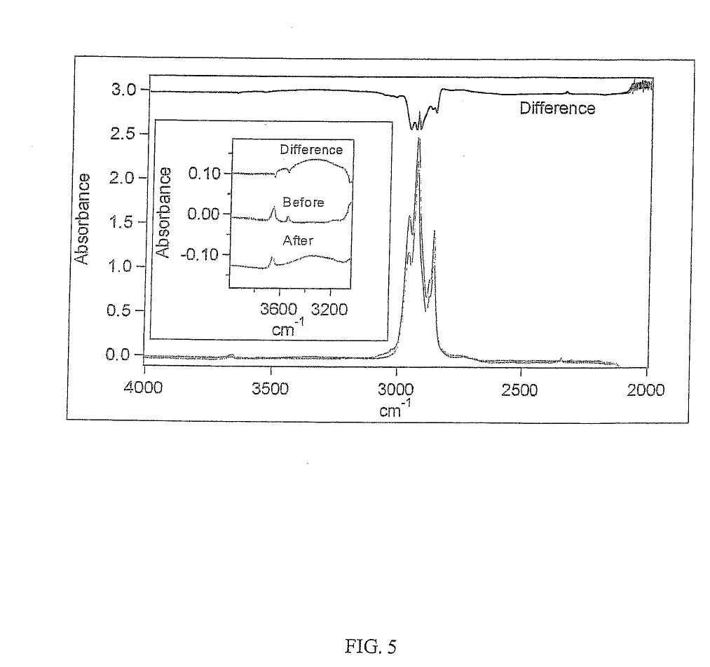

FIG. 5 shows the difference in FT-IR spectra for silica gel-purified SiCl₄ versus a SiCl₄ control sample. Negative peaks in the Difference Spectrum indicate the removal of contaminants. Smaller, relative to FIGS. 3 and 4, reductions of the peaks at 3663 cm⁻¹, 2960 cm⁻¹, 2929 cm⁻¹, 2855 cm⁻¹ and 2295 cm¹ indicated that silica gel purification of SiCl₄ reduced concentrations of contaminants containing O—H, C—H, H—Cl and Si—H bonds less effectively than purification using the zeolites CBV 400 and CBV 780. Although the contact time between SiCl₄ and silica gel was longer than the contact time between liquid SiCl₄ and the zeolite in Example 1A, the reductions in peaks at 3663 cm⁻¹, 2960 cm⁻¹, 2929 cm⁻¹, 2855 cm⁻¹ and 2295 cm⁻¹ were not as large as those produced via purification using the CBV 400 zeolite. In addition, the reductions in peaks at 3663 cm⁻¹, 2960 cm⁻¹, 2929 cm⁻¹, 2855 cm⁻¹ and 2295 cm⁻¹ were not as large as those produced via purification using the CBV 780 zeolite as described in Example 2A.

### Example 3C

This example describes the use of Inductively Coupled Plasma-Mass Spectrometry Analysis (ICP-MS) analysis to determine the efficiency of metal removal from liquid SiCl₄ using silica gel.

Analysis of metal content of silica gel -purified SiCl₄ produced as described in Example 3A and a control SiCl₄ sample was made by ChemTrace Inc., (Fremont, Calif.).

The results for metal analysis of the SiCl₄ samples are shown in Table 1, supra. The silica gel treated SiCl₄ showed similar or better reductions in metal impurities than those obtained using zeolites CBV 400 and CBV 780, as described supra. However, boron and molybdenum were detected at 0.17 ppb and 0.11 ppb, respectively, whereas neither of these impurities were detected in the control sample.

As discussed in Example 3B, the silica gel did not remove molecular contaminants as effectively as the CBV 400 and CBV 780 zeolites. The demonstrated ability of silica gel to remove aluminum, calcium and potassium, can permit the use of silica gel with zeolites such as, for example, CBV 400 and/or CBV 780 for purifying inorganic halides, e.g., silicon tetrachloride, and/or oxyhalides.

While this invention has been particularly shown and described with references to preferred embodiments thereof, it will be understood by those skilled in the art that various changes in form and details may be made therein without departing from the scope of the invention encompassed by the appended claims.

I claim:

1. A method for purifying an inorganic halide or oxyhalide feed liquid, comprising contacting the feed liquid with a zeolite to produce a purified inorganic halide or oxyhalide liquid.

2. The method of claim 1 wherein the zeolite is a type-Y zeolite in a hydrogen form.

3. The method of claim 1 wherein the zeolite has a silica-to alumina ratio of at least about 5.

4. The method of claim 1 wherein the zeolite contains a concentration of alkali or alkaline earth metal such that substantial contamination of the purified inorganic halide or oxyhalide liquid by the alkali or alkaline earth metal is prevented.

5. The method of claim 1 wherein the zeolite contains less than about 3% by weight Na₂O.

6. The method of claim 5 wherein the zeolite contains less than about 0.05% by weight Na₂O.

7. The method of claim 1 wherein the zeolite includes zeolite particles greater than about 90 microns in size.

8. The method of claim 7 wherein the zeolite includes zeolite particles greater than about 400 microns in size.

9. The method of claim 1 wherein the zeolite has a silica-to-alumina ratio of at least about 5.

10. The method of claim 9 wherein the zeolite has a silica-to-alumina ratio of at least about 80.

11. The method of claim 1 wherein the zeolite has a mean pore size of about 20 to about 30 Angstroms.

12. The method of claim 11 wherein the zeolite has a mean pore size of about 24 to about 26 Angstroms.

13. The method of claim 1 wherein the zeolite is a type-Y zeolite in a hydrogen form and has a SiO₂-to-Al₂O₃ mole ratio of about 5.1, a Na₂O weight percent of about 2.8, a unit cell size of about 24.5 Angstroms and a BET surface area of about 730 m²/gram.

14. The method of claim 1 wherein the zeolite is a type-Y zeolite in a hydrogen form and has a SiO₂-to-Al₂O₃ mole ratio of about 80, a Na₂O weight percent of about 0.03, a unit cell size of about 24.2 Angstroms and a BET surface area of about 780 m²/gram.

15. The method of claim 1 wherein the zeolite has been heated under an inert atmosphere to remove volatile species present therein.

16. The method of claim 15 wherein the zeolite has been heated to a temperature of at least about 150° C. under an inert atmosphere.

17. The method of claim 1 wherein the inorganic halide or oxyhalide is selected from the group consisting of SiCl₄, GeCl₄ and POCl₃.

18. The method of claim 1 wherein a metal impurity is removed from the feed liquid.

19. The method of claim 18 wherein the metal impurity is a metal ion.

20. The method of claim 18 wherein the metal impurity is selected from the group consisting of aluminum, antimony, barium, calcium, chromium, cobalt, copper, iron, magnesium, manganese, nickel, potassium, sodium, strontium, tin and zinc.

21. The method of claim 1 wherein a molecular impurity is removed from the feed liquid.

22. The method of claim 21 wherein the molecular impurity contains a chemical bond selected from the group consisting of C—H, Si—H, Si—OH, O—H, C—O and H—Cl.

23. The method of claim 1 wherein both metal impurities and molecular impurities are removed from the feed liquid.

24. The method of claim 1 further comprising the step of contacting the feed liquid with silica gel.

25. The method of claim 1 wherein the feed liquid is contacted with a mixture of at least one zeolite and silica gel.

26. The method of claim 1 wherein the feed liquid is contacted with a mixture of two or more zeolites.

27. The method of claim 1 wherein the feed liquid is contacted with the zeolite in a continuous process.

28. The method of claim 1 wherein the zeolite is contained in a disposable liquid filtration housing.

29. An apparatus for purifying an inorganic halide or oxyhalide feed liquid, comprising:
a) a liquid filtration housing including a liquid inlet and a liquid outlet;
and
b) a type-Y zeolite in a hydrogen form.

30. The apparatus of claim 29 further comprising a zeolite retention device.

31. The apparatus of claim 29 wherein the liquid filtration housing is composed of a chemical resistant material that is resistant to contaminating an inorganic halide or oxyhalide liquid.

32. The apparatus of claim 29 wherein the zeolite has a silica-to alumina ratio of at least about 5.

33. The apparatus of claim 29 wherein the zeolite contains a concentration of alkali or alkaline earth metal such that substantial contamination of the purified inorganic halide or oxyhalide liquid by the alkali or alkaline earth metal is prevented.

34. The apparatus of claim 29 wherein the zeolite contains less than about 3% by weight Na₂O.

35. The apparatus of claim 34 wherein the zeolite contains less than about 0.05% by weight Na₂O.

36. The apparatus of claim 29 wherein the zeolite includes zeolite particles greater than about 90 microns in size.

37. The apparatus of claim 36 wherein the zeolite includes zeolite particles greater than about 400 microns in size.

38. The apparatus of claim 29 wherein the zeolite has a silica-to-alumina ratio of at least about 5.

39. The apparatus of claim 38 wherein the zeolite has a silica-to-alumina ratio of at least about 80.

40. The apparatus of claim 29 wherein the zeolite has a mean pore size of about 20 to about 30 Angstroms.

41. The apparatus of claim 40 wherein the zeolite has a mean pore size of about 24 to about 26 Angstroms.

42. The apparatus of claim 29 wherein the zeolite has a SiO₂-to-AL₂O₃ mole ratio of about 5.1, a Na₂O weight percent of about 2.8, a unit cell size of about 24.5 Angstroms and a BET surface area of about 730 m²/gram.

43. The apparatus of claim 29 wherein the zeolite has a SiO₂-to-Al₂O₃ mole ratio of about 80, a Na₂O weight percent of about 0.03, a unit cell size of about 24.2 Angstroms and a BET surface area of about 780 m²/gram.

44. The apparatus of claim 29 wherein the zeolite is substantially free of volatile species.

45. The apparatus of claim 29 wherein the zeolite has been heated under an inert atmosphere to remove volatile species present therein.

46. The apparatus of claim 45 wherein the zeolite has been heated to a temperature of at least about 150° C. under an inert atmosphere.

47. The apparatus of claim 29 wherein the liquid filtration housing is disposable.

48. The apparatus of claim 29 wherein the liquid filtration housing is composed of perfluoroalkoxy (PFA).

49. The apparatus of claim 29 wherein the liquid filtration housing is composed of polytetrafluoroethylene (PTFE).

50. The apparatus of claim 29 further comprising liquid conduit connecting the liquid filtration housing to a manufacturing process.

51. The apparatus of claim 50 wherein the liquid conduit is composed of perfluoroalkoxy (PFA) or polytetrafluoroethylene (PTFE).
